(19) United States
(12) Patent Application Publication
(10) Pub. No.: US 2006/0105702 A1
(43) Pub. Date: May 18, 2006

(54) System and method for interactive monitoring of satellite radio use

(76) Inventors: Edwin A. Muth, Aberdeen, NJ (US); Jie Song, Macungie, PA (US)

Correspondence Address: SYNNESTVEDT LECHNER & WOODBRIDGE LLP, P O BOX 592, PRINCETON, NJ, 08542-0592, US

(21) Appl. No.: 10/991,002

(22) Filed: Nov. 17, 2004

(51) Int. Cl. H04H 9/00; H04H 7/00; H04H 1/00; H04M 3/00

(52) U.S. Cl. 455/2.01; 455/3.06; 455/3.01

(57) ABSTRACT

A system and method of monitoring Satellite Digital Audio Radio (SDAR) use in which a receiver records and stores radio-use parameters, such as a channel or song being listened to, a time a receiver is active and a signal quality and type in a flash memory. The memory can also be used to store and playback audio files. The user may be incentivised to connect to a central server to download audio material for free or at a discount, so that the stored radio use parameters can be uploaded and analyzed. The user may also be alerted when a preferred or pre-selected song or artist is available on another channel. The network connection may be via wireless access points, or suitable docking units. The receiver may also obtain and record geographical position information from a Global Positioning Satellite (GPS) system, so as monitor reception type and quality by location.

### FIELD OF THE INVENTION

The present invention relates to satellite broadcast of digital audio signals, and more particularly to apparatus and methods for automated monitoring of satellite digital audio radio service use, including data collection via non-satellite networks, and issuing user alerts responsive to the monitoring.

### BACKGROUND OF THE INVENTION

Satellite Digital Audio Radio (SDAR) services broadcast digital radio signals from satellites directly to mobile radios. SDAR broadcasts can reach an extensive geographical area because of the large footprint of the satellite transmission. This is appealing to mobile users, particularly those in automobiles or trucks, as it allows them to maintain continuity of service as they travel over relatively large distances. For instance, a commuter, or a long distance traveler, listening to an SDAR channel does not have to adjust the reception frequency, or switch to a new program, every thirty to fifty miles, as is the case if they are listening to conventional AM or FM radio stations broadcast from terrestrial transmitters.

Once example of a SDARS is that provided by Sirius Satellite Radio, Inc., of New York, N.Y. Sirius broadcasts over one hundred channels of audio programming from three geo-synchronous satellites, with a transmission footprint that covers the entire continental United States. Signals from two of the satellites can be received directly by mobile receivers small enough to be housed in a vehicle such as an automobile or a truck. The third satellite broadcasts to terrestrial repeater stations situated in urban areas, particular those areas with tall buildings that may block the satellite transmissions. The terrestrial repeater stations rebroadcast the signal to the receivers using modulation techniques that are less susceptible to interference by buildings, such as coded orthogonal frequency division modulation (COFDM). The combined system allows a user to maintain continuous access to any one of the channels, while driving virtually anywhere in the continental USA, in both rural and urban settings.

Like other radio broadcasters, SDAR broadcasters are desirous of monitoring listener response (also known as “feedback”) to their programming. Traditionally, broadcasters have used listener feedback to learn the demographics of their audience and the type of programming that appeals to them. This information is of use in, for instance, selling air-time to advertisers, and in adjusting programming content.

“Phone-ins”, in which listeners make telephone calls to the radio station to participate in a quiz or other contest, have been particularly effective in providing this listener feedback. A considerable part of a phone-in's utility is that the caller's telephone number, obtainable through caller identification circuitry, can be used to find the listener's geographical location from telephone subscriber data-based, and is, therefore a good indicator of the caller's point of reception. As a result, listener telephone calls can be used not only to estimate the size of the audience and their enthusiasm for a type of programming, but also to infer technical data such as an estimate of the quality of the broadcast signal as indicted by its reception range.

Because SDARS is intended primarily for users who are driving, and because many States have or are in the process of passing laws banning the use of phones while driving, these traditional methods of obtaining audience feedback are considerably less effective in monitoring the use of satellite broadcast radio. A further complication is that, because most SDARS listeners are mobile, even if the listeners did respond by phone, their telephone number would not be a good indicator of their point of reception.

In order to more effectively monitor listener use of SDARS, what is needed is a way of automatically recording the radio use, and a way of having that recorded data returned to a central location for assessment. It is also preferable that the geographical location of listeners be captured along with the details of their radio use.

### SUMMARY OF THE INVENTION

The present invention relates to systems and methods of monitoring satellite digital audio radio (SDAR) use. An objective of the method is to provide feedback on SDAR use in order to control the quality of both the content and the technical delivery of the satellite radio use. A further objective of the method is to provide the radio user with information regarding audio data on currently non-chosen audio channels based on prior radio-use patterns.

In a preferred embodiment, an SDAR receiver is adapted for automatic recording of aspects (also known as parameters) of radio use by adding a solid state storage device, such as flash memory. The radio-use parameters automatically stored in this memory may include, but are not limited to, which channel is being listened to, which song is being listened to, at what time the receiver is active, the signal quality and which type of signal is being received. The receiver is further adapted so that a listener can use the memory to record, and play back, audio files via the receiver. The receiver may also be adapted for connection to a conventional network such as, but not limited to, the Internet. This connection to a network may be made while the receiver is in a vehicle by, for instance, wireless connection at designated access points. Or it may utilize the fact that most receivers can be easily removed from the vehicle and taken and connected to, for instance, a personal computer or a docking device attached to a network. The user may be incentivized to make a connection to a central server by, for instance, making songs, or other audio material, available for free download by authorized users. While the user's SDAR radio receiver is connected to the central server to download the free, discounted or exclusive material, the central server may then upload the radio-use parameters stored on the radio receiver.

Once uploaded to the central server, the radio-use data may be analyzed or correlated to obtain radio-use patterns of individuals and of groups of users. These radio-use patterns may indicate usage trends such as, but not limited to, the most listened to songs and channels.

In a further embodiment of the invention, the receiver is further adapted to effectively monitor audio data available, or soon to be available, on channels not currently selected by the user, and to alert the user to audio data on any of those channels related to the user's radio-use pattern. For instance, an alert may be issued to a user to let them know that a favorite song, or a song by a favorite singer is playing, or is about to play, on another channel.

In a further embodiment of the invention, the receiver is further adapted to obtain and record geographical position information such as, but not limited to, the positional data available from a Global Positioning Satellite (GPS) system. In this way, radio use may be mapped to a physical position of a user. Furthermore, reception type and quality could be monitored by location.

These and other features of the invention will be more fully understood by references to the following drawings.

### BRIEF DESCRIPTION OF THE DRAWINGS

FIG. 1 is a schematic overview of an exemplary satellite digital audio radio service system.

FIG. 2 is a schematic view of a satellite digital audio radio service receiver in accordance with the inventive concepts of the present invention.

FIG. 3 is an exemplary embodiment of a system incorporating the inventive concepts of the present invention.

### DETAILED DESCRIPTION

The present invention relates to enhancements to a satellite digital audio radio service (SDARS), and particularly to enhancements that allow radio-use monitoring.

An SDARS is a system that broadcasts CD-like quality music and quality talk radio to mobile receivers via one or more direct broadcast satellites supplemented by gap filler terrestrial networks. A typical SDARS system operates using licensed S band spectrum (approximately 2.3 GHz) and employs time, frequency and space diversity to provide maximum service continuity.

The present invention will now be described in more detail by reference to the accompanying drawings, in which like reference figures represent like elements.

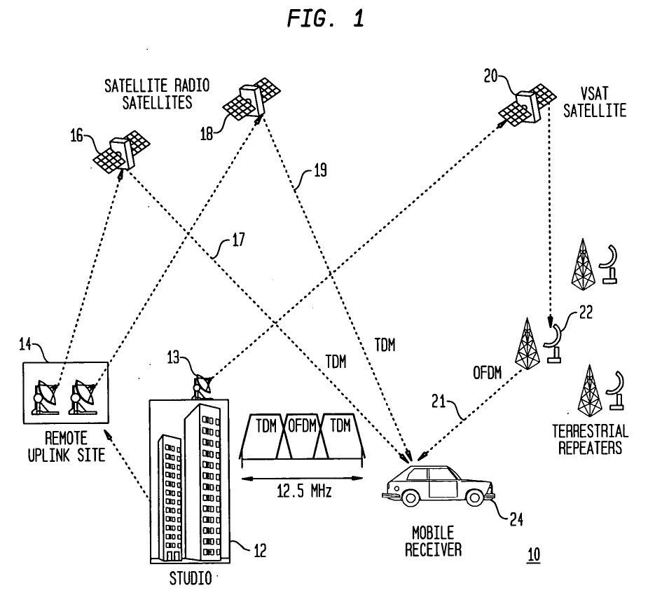

FIG. 1 is a schematic overview of an exemplary satellite digital audio radio service system 10, comprising a studio 12, a very small aperture terminal (VSAT) uplink 13, a remote uplink site 14, a first satellite 16, a second satellite 18, a VSAT satellite 20, a terrestrial repeater 22, and a mobile receiver 24.

Studio 12 is used to generate composite signals, containing audio and control channels. These composite signals are relayed to a remote uplink site 14 by landlines, and beamed up to two satellites 16 and 18, which may be in geo-stationary orbit. Satellites 16 and 18 rebroadcast the signal directly to mobile receivers 24. The composite signal is also sent via VSAT uplink 13 to a third satellite 20, which may also be a geo-stationary satellite, which then beams the signal to one or more terrestrial repeater stations 22. The repeater stations 22 then broadcast the signal to the mobile receiver 24. In an exemplary embodiment of the invention, each of the broadcast paths may occupy about one-third of the available transmission spectrum, which may be a 12.5 MHz band of licensed S band spectrum of about 2.3 GHz. In an exemplary SDARS, each of the direct from satellite 16 and 18 to mobile receiver 24 paths 17 and 19 may be a Time Division Multiplexed (TDM) encoded broadcast, with the signal in one path 17, for example satellite 16 to mobile receiver 24, delayed by a time of about 4 seconds compared to the signal from satellite 18 in reception path 19. In an exemplary SDARS, terrestrial repeaters 22 may re-transmit the signal as a coded orthogonal frequency division multiplex (COFDM) signal transmitted in reception path 21.

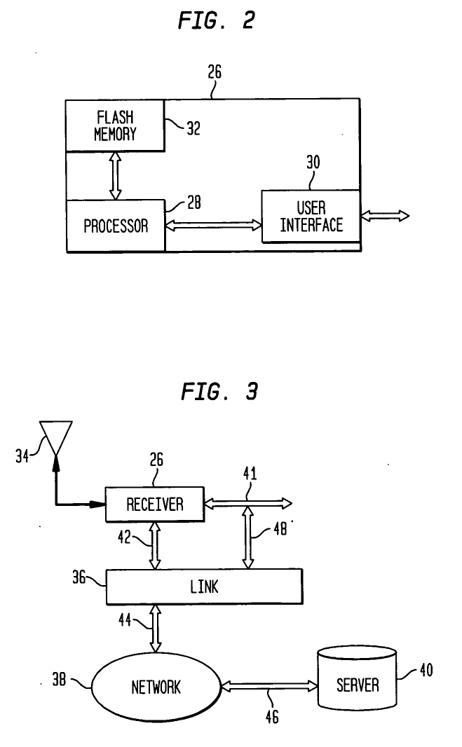

FIG. 2 is a schematic view of the relevant parts of a satellite digital audio radio service receiver 26 adapted in accordance with the inventive concepts of the present invention, comprising a processor 28, a user interface 30 and a flash memory 32.

The user selects channels for listening using the user interface 30, which may include buttons, dials, knobs and touch screens. The user interface 30 may also allows the user to adjust the volume of the radio and make choices such as, but not limited to, selecting that the radio audio be in stereo or mono audio mode, and adjusting the balance between various frequency components of the audio signal. In a preferred embodiment of the invention, the user interface also allows the user to record incoming audio into the flash memory 32, and to play-back audio already stored in the flash memory 32.

The processor 28 may be any well-known digital processor, programmed to be capable of interpreting service requests from the user interface and to record and playback audio information to flash memory 32. In a preferred embodiment, processor 28 is also capable of monitoring aspects of radio use, including parameters such as, but not limited to, a current time, a channel selection, a volume selection, a receiver active time and a song identifier, and recording relevant details of the monitored parameters in the flash memory 32. The processor 28 may also be capable of monitoring the receiver 28's incoming signal to determine the level of signal being received from each of the possible broadcast paths such as, but not limited to, from each satellite and any appropriate terrestrial repeater stations. Details of the reception such as, but not limited to, a signal type and a signal quality, may also be recorded in flash memory 32. The processor 28 may also be capable of comparing the radio parameters and determining patterns such as a most listened to or favorite channel, artist, music genre or song. The processor 28 may also be capable of providing ranked lists of radio use parameters and patterns including, but not limited to, ranked lists of most listened to channel, artist, music genre or song. The flash memory 32 may be any well known, non-volatile electronic memory that allows multiple memory locations to be erased or written in a single operation.

FIG. 3 is an exemplary embodiment of a system incorporating the inventive concepts of the present invention, comprising a SDARS receiver 26, an antenna 34, a data link 36, a network 38, a central server 40, a receiver-to-link data path 42, a link-to-network data path 44, a network-to-server data path 46, a user-receiver data path 41 and a user-link data path 48.

In a preferred embodiment of the invention, an SDARS receiver 26 intermittently establishes data contact with a central server 40. This data contact may be established via network 38, which may be any suitable data carrying network such as, but not limited to, the Internet, the public telephone system or a wireless telephone network. The receiver 26 may access the network via a link 36 and data paths 42 and 44. Link 36 may, for instance, be a docking pad on a home PC with data link 42 being any suitable cable or connector, and data link 44 may be a telephone line, a cable line or a wireless link. Link 36 may also be a wireless access point, either at a home location, or accessible while SDARS receiver 26 is in a vehicle, such as at a toll junction, a drive-thru restaurant or on a street within range of a wireless access point. In a preferred embodiment of the invention, the portable receiver 26 is docked to a PC or other networked device for synchronization.

Once the SDARS receiver 26 is in data contact with the server 40, the radio-use parameters stored in the flash memory 32 may be uploaded to the server 40 by, for instance, commands sent from the server 40 or by a software module or agent resident on processor 28. A user may also access the server 40, either by using data path 41 and the SDARS receiver 26, or by using data path 48 and the link 36.

In a preferred embodiment of the invention, the user may download audio files from the server 40 into the SDARS receiver 26 for later playback. The commercial terms of this audio download may be the incentive for the user to place SDARS receiver 26 in data contact with the central server 40 and so facilitate the upload of the stored radio-use parameters. For instance, various audio files may be made available for free as an inducement or in exchange for uploading the radio use parameters.

Once uploaded to the server, the radio use parameters, including channel selections, volume selections and the time of the selection may be analyzed against a broadcast schedule to determine what audio files were listened to by a particular user. Additionally the parameters related to signal strength may be analyzed to obtain technical data related to satellite and terrestrial repeater technical performance.

In a further embodiment of the invention, a SDARS receiver geographical position may also be recorded on a regular basis as part of the radio use parameters. The geographical position may either be obtained using a Global Positioning System (GPS) chip set incorporated into the SDARS receiver, or by taking the position information from another GPS system already incorporated in the vehicle over a suitable data interface. The geographical position information, once uploaded to the central server 40, will allow the reception related data to be correlated against location, allowing satellite and terrestrial broadcast signal strength to be analyzed.

In a further embodiment of the invention, the central receiver may combine and analyze data obtained from a plurality of radio users. The data may also be collected and combined over time.

In a further embodiment of the invention, some or all of the data analysis to obtain data use patterns may be done by circuitry on the receiver. For instance, rather than merely collecting time and channel details for forwarding to the central server, each mobile device may analyze the signal that it is tuned to and determine, for instance, what song is being played either by digital pattern recognition or by a tag attached to or embedded in the signal. Each mobile device may then tally the use of songs and send sorted, cumulative totals, which may be accumulated by day or week, to the central server, rather than raw data.

In a further embodiment of the invention, music may be downloaded to the receiver memory 32 via the satellite as well as via the network 38. This downloadable music may be available free or it may be sold by the service provider.

In a further embodiment of the invention, the user may be alerted to additional audio content from a previously listened to source. For instance, the user may be alerted to additional music, including new music, by an artist on that has been listened to before or that has been determined to be a favored artist of the listener by having been listened to a number of times. The user may also be alerted to additional audio content deemed to be similar to or related to audio content that the user has listened to previously. The alert may take the form of a preview that is pushed to the user and allows the user to then select to switch to the channel currently playing the content to which the listener has been alerted. For instance, the service provider may the user with an alert via the user interface 30. If the user accepts the alert, the processor 28 may then automatically tune the receiver 24 to a program channel containing the audio content referred to by the preview. The processor 28 may effectively monitor audio data available, or soon to be available, on channels not currently selected by the user. This may be done by, for instance downloading a detailed, periodically updated, channel programming listing to the memory. By searching the programming listing using parameters taken from the user's radio-use pattern, the processor 28 may determine the time and channel of audio data the may be of interest to the user. The processor 28 may then alert the user to that audio data by for instance, a message on the interface or by an audio message. For instance, an alert may be issued to a user to let them know that a favorite song, or a song by a favorite singer is playing, or is about to play, on another channel. The user may then select to switch to that channel. The user may also elect to override the alerts or to turn the alert system on or off. The user may also edit the radio-use patterns used in the alert. For instance, the alerts may be responsive to a top ten list of favorite songs. The user may, for instance, edit by adding or removing songs, or by changing a priority order thereby overriding the order assigned by the processor that was based on user radio-use data.

Although the invention has been described in relation to an SDARS, it would be obvious to one of ordinary skill in the art to apply some or all of the inventive concepts described herein to other systems such as, but not limited to, mobile wireless devices, cellular phones and land mobile radio systems.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method of monitoring the use of a radio receiver, comprising the steps of:
recording a radio-use parameter;
accessing a central server using said receiver; and
transferring said radio-use parameter from said receiver to said central server.

2. The method recited in claim 1, further comprising the step of downloading an audio file from said central server to said receiver.

3. The method recited in claim 2, wherein said steps of downloading and transferring occur concurrently.

4. The method recited in claim 1, wherein said step of recording occurs while said radio receiver is mobile.

5. The method recited in claim 1, wherein said radio-use parameter is selected from at least one of a channel being used, a receiver active time, a volume, a song identifier, a signal type and a signal quality.

6. The method recited in claim 1, wherein said step of recording further comprises recording a plurality of radio-use parameters; and further comprises the steps of analyzing said plurality of radio use parameters to determine a pattern of use.

7. The method recited in claim 6, wherein said pattern of use is at least one of a favorite song, a favorite channel and a most likely time of use.

8. The method recited in claim 6, further comprising the step of issuing an alert detailing availability of audio data related to said pattern of use.

9. The method recited in claim 8, further comprising the step of automatically tuning to a program channel containing said audio data related to said pattern of use.

10. The method recited in claim 1, further comprising providing a geographic position locator; recording a location related parameter; and transferring said geographic position locator to said central server.

11. The method recited in claim 8, wherein said location related parameter is at least one of a longitude, a latitude and an elevation.

12. The method recited in claim 8, further comprising linking said radio use parameter to said location related parameter.

13. The method recited in claim 6, wherein said pattern of use is a reception type by location and a quality by location.

14. An apparatus for monitoring the use of a radio receiver, comprising:
a memory capable of recording a radio-use parameter;
a data uplink, capable of linking said memory to a central server via a network; and
a data file up-loader, capable of uploading said radio-use parameter from said memory to said central server.

15. The apparatus recited in claim 14, further comprising an audio file down-loader, capable of downloading an audio file from said central server to said radio;

16. The apparatus recited in claim 15, wherein said audio file down-loader and said data file up-loader are capable of simultaneous operation.

17. The apparatus recited in claim 14, wherein said radio-use parameter is at least one of a channel being used, a receiver active time, a volume, a song identifier, a signal type and a signal quality.

18. The apparatus recited in claim 14, further comprising a data analysis module capable of analyzing a plurality of said radio use parameters to determine a pattern of use.

19. The apparatus recited in claim 14, wherein said pattern of use is at least one of a favorite song, a favorite channel and a most likely time of use.

20. The apparatus recited in claim 12, further comprising a geographic position locator capable of interfacing with said memory.

21. The apparatus recited in claim 20, wherein said geographic position locator is capable of providing a location related parameter, and said location related parameter is at least one of a longitude, a latitude and an elevation.

22. The method recited in claim 21, wherein said data analysis module is further capable of linking said radio use parameter to said location related parameter.

23. A method for monitoring usage parameters of a mobile electronic device, said method comprising the steps of:
a) storing in a memory within said mobile electronic device at least one usage parameter of said mobile electronic device;
b) offering an incentive to a user of said mobile electronic device to permit said downloading step to occur; and
downloading said usage parameter from said memory to a device external to said mobile electronic device.

24. The method of claim 23 further comprising the step of:
repeating steps a) and b) for a plurality of mobile electronic devices; and
correlating/analyzing said usage parameter to determine patterns among users of said mobile electronic devices.
